(19) United States
(12) Patent Application Publication
(10) Pub. No.: US 2017/0300678 A1
(43) Pub. Date: Oct. 19, 2017

(54) METHOD AND APPARATUS FOR USING A BIOMETRIC TEMPLATE TO CONTROL ACCESS TO A USER CREDENTIAL FOR A SHARED WIRELESS COMMUNICATION DEVICE

(71) Applicant: MOTOROLA SOLUTIONS, INC, SCHAUMBURG, IL (US)

(72) Inventors: ANTHONY R. METKE, NAPERVILLE, IL (US); MICHAEL F. KORUS, EDEN PRAIRIE, MN (US); GEORGE POPOVICH, PALATINE, IL (US)

(21) Appl. No.: 15/097,767

(22) Filed: Apr. 13, 2016

(51) Int. Cl. G06F 21/32; H04W 12/06; H04L 9/32

(52) U.S. Cl. CPC G06F 21/32; H04L 9/3231; H04W 12/06

(57) ABSTRACT

Methods and apparatus for using a biometric template to control access to a user credential for a shared wireless communication device. One method includes receiving, from a mobile device, an authentication request. The authentication request includes a device credential associated with the mobile device. The method further includes receiving, from the mobile device, a request for a biometric template of a user. The method further includes determining, by reference to at least one of a group consisting of the device credential and an authorization database, that the mobile device is authorized to receive the biometric template of the user based on at least one attribute controlling a use of the biometric template. The method further includes, in response to determining that the mobile device is authorized to receive the biometric template of the user, conveying the biometric template of the user to the mobile device.

### BACKGROUND OF THE INVENTION

A digital certificate may be created in a public key infrastructure (PKI) and may be used to identify ownership of a public key as a part of a cryptographic protocol executed to authenticate an end entity (that is, a user or wireless communication device) and subsequently grant access to a service. In order to obtain the digital certificate from a PKI, the end entity typically sends a certificate signing request to a component (for example, a registration authority (RA) or a certificate authority (CA)) in a PKI. The certificate generated by the PKI certifies the ownership of a public key by the named subject of the certificate and binds an identity of the end entity to the public key by including the identity of the end entity and the public key in the certificate and signing the certificate with the private key of a trusted CA. The CA may include other information about the end entity in the certificate. For instance, the CA may include attributes that can be used to provide an indication of the applications and services that the end entity should be allowed to access, or other attributes of the end entity such as a role or rank, or group affiliation. Once generated, the digital certificate allows others (relying parties) to rely upon signatures or assertions made by a private key that corresponds to the public key in the certificate. The process of obtaining a certificate is referred to herein as certificate enrollment.

To enhance the security surrounding certificate enrollment, some wireless communication devices further include biometric authentication. For example, when a user first authenticates to a device, the user can be required to provide biometric information. Typically, such biometric identification also is stored on the user's device. If the biometric information input by the user matches the biometric identification maintained by the device then the user is permitted access to the device. Such biometric information further may be used to authenticate the user in obtaining a certificate.

### BRIEF DESCRIPTION OF SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless communication system in which service instance selection is implemented in accordance with some embodiments of the present invention.

FIG. 2 is a block diagram of a mobile device of the wireless communication system of FIG. 1 in accordance with some embodiments of the present invention.

FIG. 3 is a block diagram of a user credential server of the wireless communication system of FIG. 1 in accordance with some embodiments of the present invention.

FIG. 4 is a block diagram of a service network element of the wireless communication system of FIG. 1 in accordance with some embodiments of the present invention.

FIG. 5A is a logic flow diagram illustrating a method performed by the wireless communication system of FIG. 1 in controlling a distribution of a user biometric template in accordance with some embodiments of the present invention.

FIG. 5B is continuation of the logic flow diagram of FIG. 5A illustrating a method performed by the wireless communication system of FIG. 1 in controlling a distribution of a user biometric template in accordance with some embodiments of the present invention.

FIG. 6 is a logic flow diagram illustrating a method performed by the wireless communication system of FIG. 1 in controlling access to a user credential in accordance with some embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE INVENTION

In a public safety network, such as First Responder Network (FirstNet), a mobile wireless communication device can be shared among numerous users from an agency and across multiple work shifts. Such shared wireless communication devices may be referred to herein as shared devices or shareable devices. Further, such shared devices can be shared somewhat randomly, wherein a user starting a work shift may randomly pick up any one of multiple mobile devices available for use. In such instances, a single certificate issued to the device cannot be used to identify the current user of the mobile device.

In addition, it is also infeasible to provision the shared device with biometric templates and certificates for each and every potential user of the device. That is, if biometric templates and certificates are issued for all users sharing a device, the shared device may have to store biometric templates and certificates for, in some cases, hundreds of users. If the shared device with biometric templates and certificates for multiple users is lost or stolen, the biometric template and certificate for each user that is stored in the device would have to be revoked. Furthermore, because each user is set up to share multiple devices, a user could have at least one biometric template and certificate on each shared device. When a user with a biometric template and certificate on multiple shared devices is terminated by the enterprise, the user biometric template and certificate may have to be removed from each of the shared devices.

Accordingly, one exemplary embodiment provides a method for controlling access to a user credential using a biometric template. The method includes receiving, from a mobile device, an authentication request. The authentication request includes a device credential associated with the mobile device. The method further includes receiving, from the mobile device, a request for a biometric template of a user. The method further includes determining, by reference to at least one of a group consisting of the device credential and an authorization database, that the mobile device is authorized to receive the biometric template of the user based on at least one attribute controlling a use of the biometric template. The method further includes, in response to determining that the mobile device is authorized to receive the biometric template of the user, conveying the biometric template of the user to the mobile device.

Another exemplary embodiment provides a method for authenticating a user on a mobile device. The method includes receiving, by a input/output interface of the mobile device, a user identifying input. The method further includes, in response to receiving the user identifying input, authenticating, by the mobile device, to a biometric template server. The method further includes, in response to authenticating to the biometric template server, conveying, by the mobile device to the biometric template server, the user identifying input. The method further includes, in response to conveying the user identifying input, receiving, by the mobile device, one or more messages including a biometric template for the user. The method further includes authenticating, by the mobile device, the user based on the biometric template.

Another exemplary embodiment provides a mobile device. The mobile device includes an input/output interface, a wireless interface, a processor, and at least one memory device. The memory device is configured to store a set of instructions that, when executed by the processor, cause the processor to receive, via the input/output interface, a user identifying input from a user of the mobile device. The memory device is further configured to cause the processor to, in response to receiving the user identifying input, authenticate to a biometric template server and convey, to the biometric template server via the wireless interface, the user identifying input. The memory device is further configured to cause the processor to, in response to conveying the user identifying input, receive, via the wireless interface, one or more messages including a biometric template for the user. The memory device is further configured to cause the processor to, authenticate the user based on the biometric template. The memory device is further configured to cause the processor to assemble a request for a user credential based on metadata included in the one or more messages. The memory device is further configured to cause the processor to sign the request for a user credential to produce a signed request. The memory device is further configured to cause the processor to, convey, via the wireless interface, to a user credential server, the signed request. The memory device is further configured to cause the processor to, in response to conveying the signed request, receive, via the wireless interface, the user credential.

It should be noted that, for ease of description, the exemplary embodiments provided herein are described in terms of uploading and downloading a single biometric template. However, a single biometric template may include one or more biometric identifiers (for example, an iris scan, fingerprint, palm print, facial-recognition-ready photograph, voice data, an electrocardiogram, and the like), which may be used to authenticate an associated user.

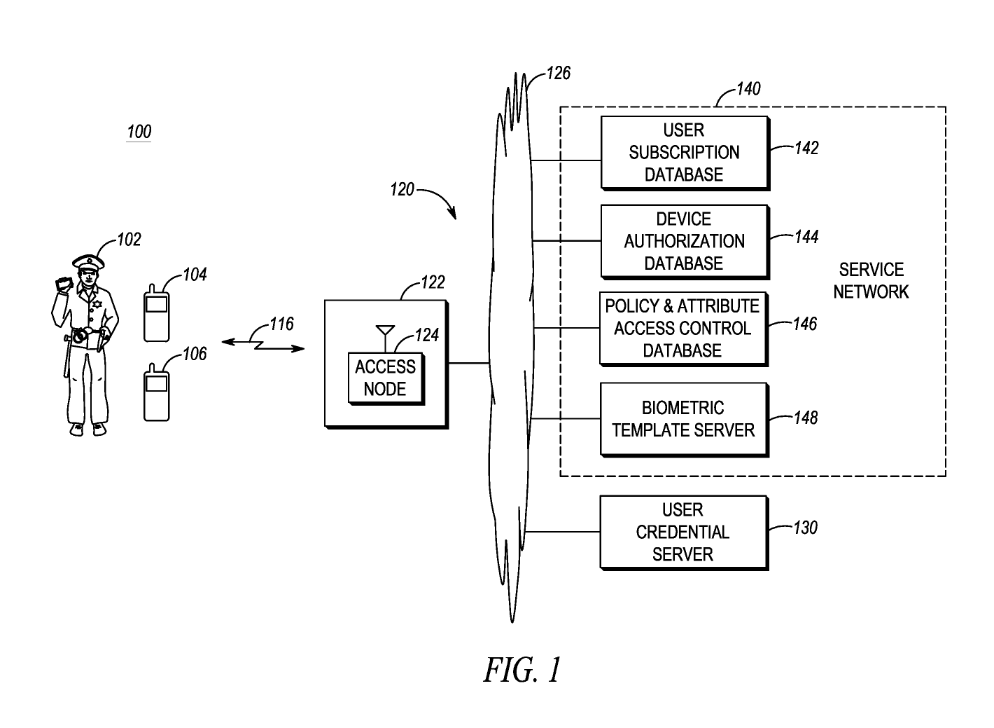

FIG. 1 illustrates an exemplary embodiments of a wireless communication system 100 in accordance with an embodiment of the present invention. The wireless communication system 100 includes a first mobile device 104 and a second mobile device 106. As set forth in detail below, the first mobile device 104 and the second mobile device 106 may be any mobile wireless communication device that includes functionality to allow biometric authentication and to securely authenticate users. In some embodiments, the biometric authentication (that is, the comparison of a biometric sample to a biometric template) is performed on the first mobile device 104 and the second mobile device 106, and the collection of a biometric sample is performed by one or more collection devices linked to, but separate from, the first mobile device 104 and the second mobile device 106. For example, in some embodiments, a body worn biometric sensor (e.g., a biometric bracelet or watch) may be connected via a wired or wireless connection to the first mobile device 104, the second mobile device 106, or both. Each of the first mobile device 104 and the second mobile device 106 may be, for example, a cellular telephone, a smart phone, a Land Mobile Radio (LMR), a personal digital assistant (PDA), laptop computer, or personal computer with radio frequency (RF) capabilities, or any other type of mobile device with wide area wireless communication capabilities, such as wide area network (WAN) or wireless local area network (WLAN) capabilities, and/or short-range wireless communication capabilities, such as Bluetooth or near-field communication (NFC) capabilities. In various technologies, the first mobile device 104 and the second mobile device 106 may be referred to as a mobile station (MS), user equipment (UE), user terminal (UT), subscriber station (SS), subscriber unit (SU), remote unit (RU), access terminal, and so on.

The wireless communication system 100 further includes an infrastructure 120 comprising a radio access network (RAN) 122 that is in communication, via a data network 126, with a user credential server 130 and a public safety agency or enterprise service network 140 (hereinafter referred to as a “service network 140”). In various embodiments, the user credential server 130 may be part of the service network 140 or may be separate from, and accessible by, the service network 140.

The RAN 122 includes a wireless access node 124 that provides wireless communication services to mobile devices (for example, the first mobile device 104 and the second mobile device 106) residing in a coverage area of the access node via a corresponding air interface, such as the air interface 116. The air interface 116 includes an uplink and a downlink, which uplink and downlink each include multiple traffic channels and multiple signaling channels. The wireless access node 124 may be any network-based wireless access node, such as a Node B, an evolved Node B (eNB), an access point (AP), or base station (BS). The RAN 122 also may include one or more access network controllers (not shown), such as a Radio Network Controller (RNC) or a Base Station Controller (BSC), coupled to the one or more wireless access nodes; however, in various embodiments of the present invention, the functionality of such an access network controller may be implemented in the access node.

The user credential server 130, may be one or more of an identity management server (IdM), a Registration Authority (RA), a Certificate Authority (CA), an entire public key infrastructure (PKI) (containing an RA and CA as well as other PKI components), or any other type of public key cryptography system that manages public keys. The user credential server 130 issues and maintains user credentials for each of the users of the wireless communication system 100. The user credentials may include a signed data structure, for example, a digital certificate or an identity token, that a user can use to authenticate himself or herself to other elements of wireless communication system 100 and/or establish a secure connection with such other elements.

The service network 140 includes a user subscription database 142 (for example, a Home Subscriber Server (HSS)), which maintains subscription and profile information for each user subscribed to the services of the service network 140 (for example, user 102). Some embodiments refer to the user 102 as a subscriber. The profile information for the user 102 may include a role of the user 102 in the wireless communication system 100 (for example, an employment area, title, or responsibility associated with the user 102), or a relationship between the user 102 and one or more other members of a communication group that includes the user 102. The profile information for the user 102 may also include a rank or other prioritization of the user 102 over another user (for example, whether the user 102 is a fire/police officer or non-officer, or whether the user is a fire/police battalion commander, lieutenant, or sergeant). The profile information for the user 102 may also identify a service network sub-network, such as a service network department or precinct, to which the user 102 belongs.

The service network 140 further includes a device authorization database 144, a policy and attribute access control database 146, and a biometric template server 148. In one embodiment, the device authorization database 144 maintains a list of identifiers of mobile devices, such as the first mobile device 104 and the second mobile device 106, that are shareable devices, that is, that may be used by each of multiple different users, such as the user 102. As explained in detail below, some embodiments provide shareable devices that are enhanced to perform biometric authentication to control which users can authenticate to the service network 140 using the devices.

The policy and attribute access control database 146 maintains attributes of users (“authorization attributes”), such as the user 102, who are authorized to use a shared device, such as the first mobile device 104 and the second mobile device 106. The policy and attribute access control database 146 also maintains policies controlling such users' use of a shared device with the service network 140, such as contextual and situational conditions on use. Such attributes may include, for example, the user profile information as described above. Other attributes may include mobile device types (such as mobile device brands, mobile devices having certain applications available, such as voice, video, data, and Push-to-Talk (PTT), or mobile devices supporting certain versions of hardware or software) or mobile device pools (for example, a list or range of identifiers of multiple shared mobile devices) that a user is limited to using; applications, functions, or resources of a shared device that a user is allowed to access/use; a user assurance level, that is, a level of authentication that a user is considered to be authenticated at when the user is authenticated using a biometric template; and attributes controlling the use of the biometric template (for example, whether the biometric template is for use merely in an initial authentication of the user or may also be used for continuous authentication). Such policies and attributes may also include a biometric template lifetime, that is, a limited period of time during which a biometric template is valid and the corresponding user is allowed to use the shared device. When the biometric template lifetime expires, a mobile device storing or using the biometric template deletes the biometric template, and may be required to delete any user credentials, such as certificates, downloaded by the mobile device from the user credential server 130 during the lifetime of the biometric template. Similarly, attributes may include attributes controlling the users' use of a user credential, such as a user credential validity period, which limits the useful life of a received user credential, and a user credential subject name. The policy and attribute access control database 146 may be pre-provisioned into the service network 140 by an operator of the service network 140.

The biometric template server 148 maintains a biometric template for each user authorized to use a shared device, such as the first mobile device 104 and the second mobile device 106, and further maintains a user identifying input or inputs associated with each biometric template. Each biometric template maintained by the biometric template server 148 includes any one or more types of biometric data, that is, one or more biometric identifiers (for example, an iris scan, fingerprint, palm print, facial-recognition-ready photograph, voice data, an electrocardiogram, and the like) that may be used to authenticate an associated user. The user identifying input includes data (for example, a user name, codeword, key, personal identification number, or voice input such as the user saying his or her name, and the like), that may be input to a mobile device by a user, such as the user 102, of the mobile device and that can be used by biometric template server 148 to uniquely identify a biometric template of the user. Thus, when a mobile device, such as the first mobile device 104 and the second mobile device 106, provides a user identifying input to biometric template server 148, the biometric template server 148 can retrieve a biometric template associated with the received user identifying input, and return the retrieved biometric template to the mobile device.

As the user subscription database 142, device authorization database 144, policy and attribute access control database 146, and biometric template server 148 are each an element of service network 140, each may be referred to as a service network element of the wireless communication system 100. Furthermore, as the elements of the RAN 122, such as the wireless access node 124, data network 126, user credential server 130, and the multiple service network elements 142, 144, 146, and 148 are each an element of the infrastructure 120, each may also be referred to as an infrastructure element of the wireless communication system 100. The infrastructure 120 can be any type of communication network, wherein the first mobile device 104 and the second mobile device 106 communicate with infrastructure elements using any suitable over-the-air protocol and modulation scheme. Although not shown, the infrastructure 120 may include a further number of infrastructure elements for a commercial embodiment that are commonly referred to as, but not limited to, bridges, switches, zone controllers, routers, authentication centers, or any other type of infrastructure equipment facilitating communications between entities in a wireless or wired network environment. Finally, it should be noted that the wireless communication system 100 is illustrated by reference to a limited number of devices for ease of illustration. However, any suitable number of mobile devices and infrastructure elements may be implemented in a commercial system without loss of generality of the teachings herein.

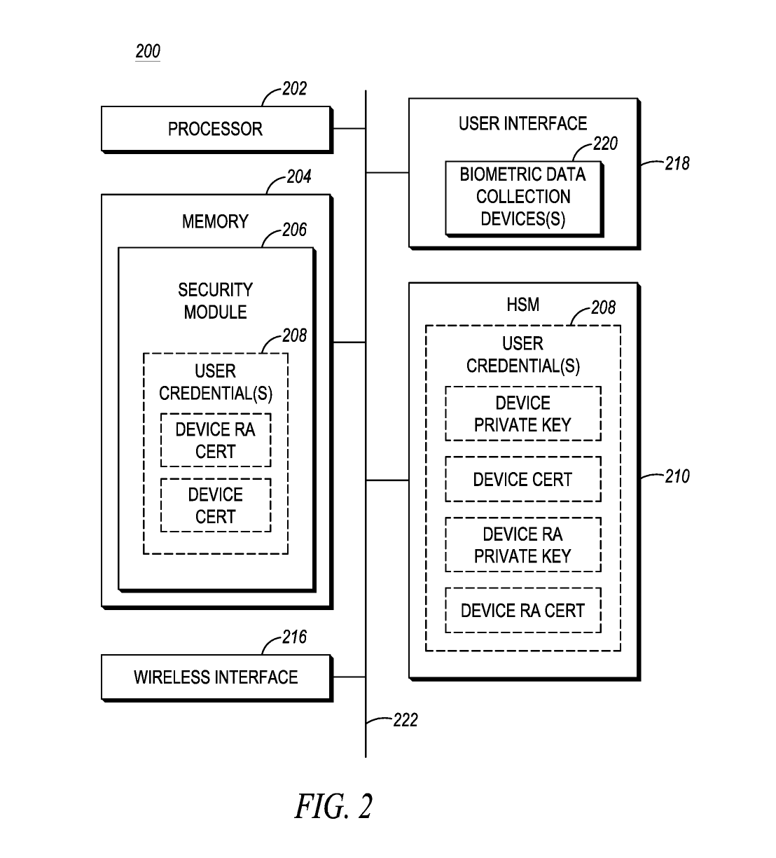

FIG. 2 is a block diagram of one exemplary embodiment of a shared mobile device 200, which is representative of the first mobile device 104 and the second mobile device 106. The mobile device 200 generally includes a processor 202, at least one memory device 204, a wireless interface 216, and an input/output (I/O) interface 218. It should be appreciated by those of ordinary skill in the art that FIG. 2 depicts the mobile device 200 in an oversimplified manner, and a practical embodiment may include additional components and suitably configured processing logic to support known or conventional operating features that are not described in detail herein.

The mobile device 200 operates under the control of the processor 202, such as one or more microprocessors, microcontrollers, digital signal processors (DSPs), combinations thereof or such other devices known to those having ordinary skill in the art. The processor 202 operates the corresponding mobile device according to data and instructions stored in the at least one memory device 204, such as random access memory (RAM), dynamic random access memory (DRAM), and/or read only memory (ROM) or equivalents thereof, that stores data and instructions that may be executed by the corresponding processor so that the mobile device may perform the functions described herein.

The data and instructions maintained by the at least one memory device 204 include software programs that include an ordered listing of executable instructions for implementing logical functions. For example, the software in at least one memory device 204 may include a suitable operating system and software programs. The operating system controls the execution of other computer programs, and provides scheduling, input-output control, file and data management, memory management, and communication control and related services. The programs may include various or applications (“apps”), add-ons, and the like configured to provide user functionality with the mobile device 200. The at least one memory device 204 also maintains one or more mobile device identifiers (for example, a mobile station identifier (MS ID), a subscriber unit identifier (SU ID), an International Mobile Subscriber Identity (IMSI), or a Temporary Mobile Subscriber Identity (TMSI)) that uniquely identify the mobile device 200 in the wireless communication system 100. The at least one memory device 204 also maintains a service network identifier, which identifies the service network 140 (for example, a public safety agency), to which the mobile device belongs, and a service network sub-network identifier which identifies the sub-network (for example, an identifier of a department or a precinct of the public safety agency) of the service network 140, to which the mobile device belongs.

The mobile device 200 further includes a security module 206. The security module 206 includes security functions such as, for example, encryption, decryption, key generation, certificate data signing, and the like. The security module 206 may be implemented in hardware, software, or a combination thereof. The security module 206 also includes algorithms for generating, sending, receiving, manipulating, and storing the user credentials 208, private keys, public keys, digital certificates, identity tokens, and the like for use in secure authentication to the service network 140 (or elements thereof). In some embodiments, the security module 206 maintains an encryption/decryption key that is shared with biometric template server 148 and that may be used to encrypt and decrypt a biometric template maintained by the biometric template server 148. In other embodiments, the security module 206 and the biometric template server 148 do not share a symmetric key. Instead, the security module 206 has access to the public key of the biometric template server 148, and the biometric template server 148 has access to the public key of the security module 206.

In one embodiment of the present invention, mobile device 200 may additionally include a hardware security module (HSM) 210. The HSM 210 is a hardware-based encryption and key management device that provides hardware-based cryptographic functions similar to the security module 206, and provides tamper protection for the user credentials 208. When the HSM 210 is used, the device private keys are generated in the HSM and are not exposed to any other component of the mobile device, but a CA certificate and a device RA certificate maintained by the HSM 210 can be copied to the at least one memory device 204 for efficiency of cryptographic operations. In some embodiments, the HSM 210 is a CRYPTR™ micro chip available from Motorola Solutions, Inc., which micro chip may be installed in a microSD slot of a mobile device. A CRYPTR-based PKI operation is more secure than a software-based key storage approach. That is, the CRYPTR generates and stores private keys in a tamper resistant hardware security module. For any PKI operation, data is sent to the CRYPTR and the CRYPTR does the signing and returns the signed data to a requesting application. Thus, the private keys are never exposed to any application executing on a mobile device.

The wireless interface 216 facilitates an exchange of wireless communications with the RAN 122. For example, the wireless interface 216 may include a wireless area network (WAN) radio transceiver with a corresponding antenna for exchanging WAN communications with the RAN 122.

The I/O interface 218 allows a user to input information into, and receive information from, the mobile device 200. For example, the I/O interface 218 may include a keypad, a touch screen, a scroll ball, a scroll bar, buttons, bar code scanner, a microphone, and the like. Further, the I/O interface 218 may include a display device such as a liquid crystal display (LCD), touch screen, and, a audio speaker the like for displaying system output. The I/O interface 218 also includes one or more biometric data collection devices 220 that collect biometric data from a user of the mobile device, for example, user 102, and store the collected biometric data in at least one memory device 204. For example, the one or more biometric data collection devices 220 may include an imaging device, such as a digital camera, that the user 102 can use to take his or her picture, a fingerprint scanner that the user 102 can use to scan his or her fingerprint into the mobile device 200, an iris scanner that the user 102 can use to scan his or her iris pattern into the mobile device 200, or a microphone that collects voice audio patterns of the user 102. The collected biometric data of the user 102 may be conveyed to the service network 140 for storage in the biometric template server 148, or it may be compared to a biometric template downloaded by the mobile device 200 from biometric template server 148 to verify an identity of a user attempting to use the mobile device 200.

The I/O interface 218 may also include, for example, a serial port, a parallel port, a small computer system interface (SCSI), an infrared (IR) interface, a universal serial bus (USB) interface, a microSD slot, and the like for communicating with, or coupling to, an external device.

The components (202, 204, 210, 216, and 218) of the mobile device 200 are communicatively coupled via a local interface 222. The local interface 222 may be, for example, one or more buses or other wired or wireless connections, as is known in the art. The local interface 222 may have additional elements, which are omitted for simplicity, such as controllers, buffers (caches), drivers, repeaters, and receivers, among many others, to enable communications. Furthermore, the local interface 222 may include address, control, and/or data connections to enable appropriate communications among the aforementioned components. In one embodiment the one or more biometric data collection devices 220 may be physically located on a separate device that this is securely paired to the mobile device 200 using, for example, Bluetooth or another suitable wireless protocol.

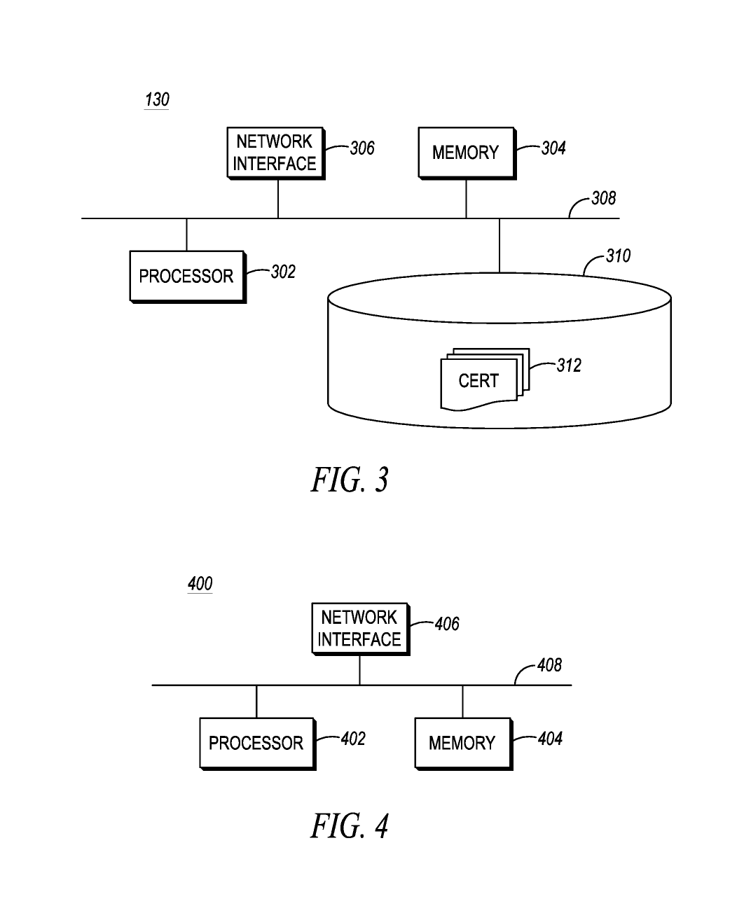

FIG. 3 illustrates an exemplary embodiments of a user credential server 130. The user credential server 130 may be, for example, a public key infrastructure element such as a Registration Authority (RA) and/or a Certificate Authority (CA). The user credential server 130 operates under the control of a processor 302, for example, one or more microprocessors, microcontrollers, digital signal processors (DSPs), combinations thereof or such other devices known to those having ordinary skill in the art. The processor 302 operates the user credential server 130 according to data and instructions stored in an at least one memory device 304, such as random access memory (RAM), dynamic random access memory (DRAM), and/or read only memory (ROM) or equivalents thereof, that stores data and programs that may be executed by the corresponding processor so that the server may perform the functions described herein.

The user credential server 130 further includes one or more network interfaces 306 for connecting to other elements of the infrastructure 120, such as the user subscription database 142, device authorization database 144, policy and attribute access control database 146, biometric template server 148, and data network 126. The user credential server 130 communicates via the one or more network interfaces 306 and the data network to other devices of the wireless communication system 100, such as the first mobile device 104 and the second mobile device 106. The one or more network interfaces 306 may include a wireless, a wireline, and/or an optical interface that is capable of conveying messages (for example, data packets) to, and receiving messages from, the data network 126.

The user credential server 130 further includes, or is in communication with via the one or more network interfaces 306, a Certificate Repository (CR) 310. In some embodiments, the CR 310 is implemented with an electronic database, which is used to provide persistent storage digital certificates 312, such as, for example, user certificates, RA certificate 134, CA certificate 138, and device certificates associated with the first mobile device 104 and the second mobile device 106, which device certificates may be used by the user credential server 130 to validate, and securely communication with, the mobile devices. In some embodiments, the first mobile device 104 and the second mobile device 106 use a public key pair without a certificate to authenticate to the user credential server 130, the biometric template server 148, and other servers of the service network 140. The components (302, 304, 306, 310) of the user credential server 130 are communicatively coupled via a local interface 308. The local interface 308 may be, for example, one or more buses or other wired or wireless connections, as is known in the art. The local interface 308 can have additional elements, which are omitted for simplicity, such as controllers, buffers (caches), drivers, repeaters, and receivers, among many others, to enable communications. Furthermore, the local interface 308 may include address, control, and/or data connections to enable appropriate communications among the aforementioned components.

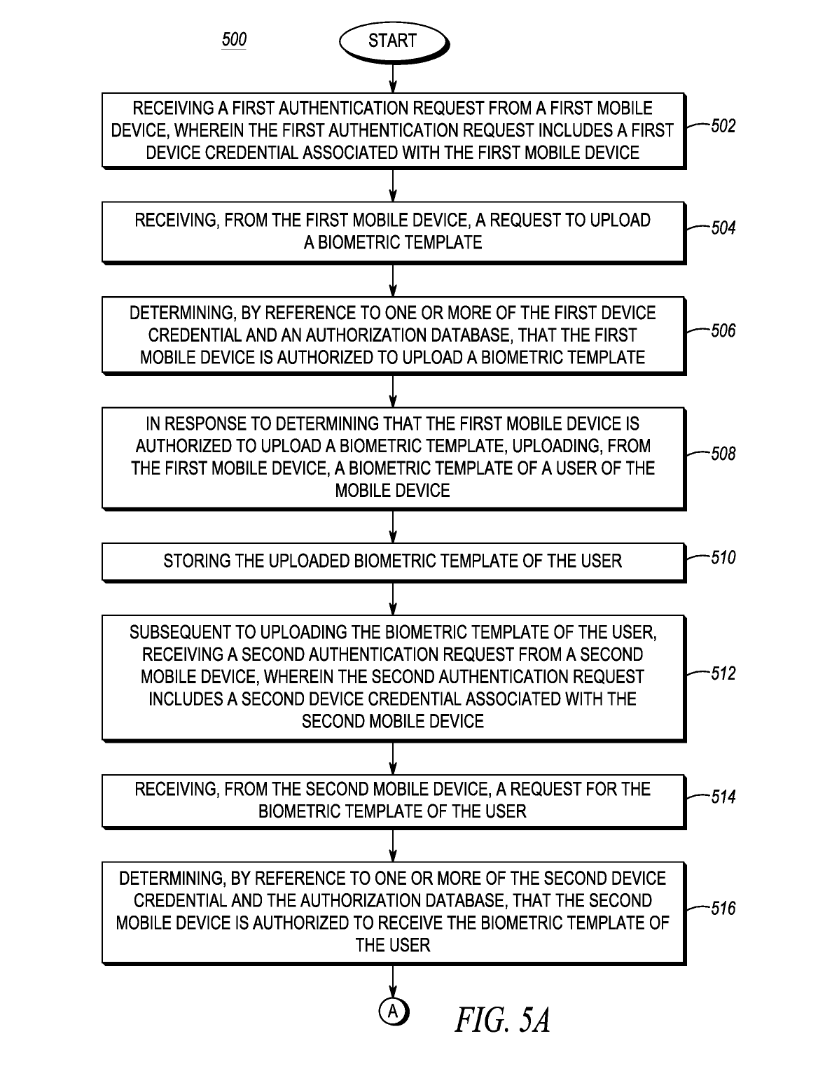

FIG. 4 illustrates an exemplary embodiment of a service network element 400, such as the user subscription database 142, device authorization database 144, policy and attribute access control database 146, and biometric template server 148. The service network element 400 includes a processor 402, for example, one or more microprocessors, microcontrollers, digital signal processors (DSPs), combinations thereof or such other devices known to those having ordinary skill in the art. The service network element 400 further includes at least one memory device 404, such as random access memory (RAM), dynamic random access memory (DRAM), and/or read only memory (ROM) or equivalents thereof, which is in communication with the processor 402 via a corresponding local interface 408. Each of the at least one memory devices 404 stores data and programs, such as group call programs, that may be executed by the processor 402 and that allow the service network element 400 to perform functions to operate in wireless communication system 100.

In one embodiment, the memory of the device authorization database 144 maintains a list of mobile devices, such as the first mobile device 104 and the second mobile device 106, that are shareable devices (that is, that may be used by each of multiple different users, such as user 102). It should be noted that, in some embodiments, the device authorization database 144 is not used. In such embodiments, the device certificate issued to the mobile device contains one or more attributes that indicate to the biometric template server 148 that the mobile device is authorized to request a biometric template, and that indicate to the user credential server 130 that the mobile device is authorized to request a user credential.

The memory of the policy and attribute access control database 146 maintains attributes of users (for example, contextual and situational conditions on use), such as the user 102, who are authorized to use a shared device, and policies controlling such users' use of the shared device to access the service network 140.

The memory of the biometric template server 148 maintains a biometric template for each user authorized to use a shared device. The biometric template server 148 may be pre-provisioned with the biometric templates by an operator of service network 140 or may, as described in detail below, receive a biometric template from a user via a mobile device when the user initially enrolls in service network 140.

The service network element 400 further includes one or more network interfaces 406 (one shown) that are in communication with the processor 402 via the respective local interface 408 and that provides for interfacing with other service network elements and with other infrastructure elements of the wireless communication system 100. The local interface 408 may be, for example, one or more buses or other wired or wireless connections, as is known in the art. The local interface 408 may include additional elements, which are omitted for simplicity, such as controllers, buffers (caches), drivers, repeaters, and receivers, among many others, to enable communications. Furthermore, the local interface 408 may include address, control, and/or data connections to enable appropriate communications among the aforementioned components of the service network element 400.

Unless otherwise specified herein, the functionality described herein as being performed by a mobile device (such as first mobile device 104 or the second mobile device 106), the user credential server 130, a service network element 400 (such as the user subscription database 142, the device authorization database 144, the policy and attribute access control database 146, and the biometric template server 148) is implemented with or in software programs and instructions stored in the respective memory and executed by the associated processor.

A user credential scheme, for example, a PKI scheme, uses a user credential, such as a digital certificate, to verify that a particular public key belongs to a certain end entity (for example, the user 102) and may be used for access control. The certificate is an electronic document that is issued by a trusted party and that is used to prove ownership of a public key. The certificate includes information about the key and an identity of the key owner, and further includes a digital signature of a Certificate Authority (CA), that is, an entity that has verified that the certificate's contents are correct. In order to obtain a user credential on a mobile device, a user, via client software on a mobile device of a user, has to go through a user credential enrollment process with the user credential server. In some cases, the user credential server 130 may include a CA that issues and controls the life cycle of the user certificates, and may include an RA that performs the user/mobile device authentication for the CA before any user credential can be generated for the user/mobile device. In order to provide for secure user credential enrollment for a user of a shared mobile device, the wireless communication system 100 provides for an infrastructure-based storage of biometric templates of users, wherein a biometric template for a given user may be downloaded by a shared mobile device when that user logs into the device and then may be used to authenticate the user as part of a user credential enrollment process.

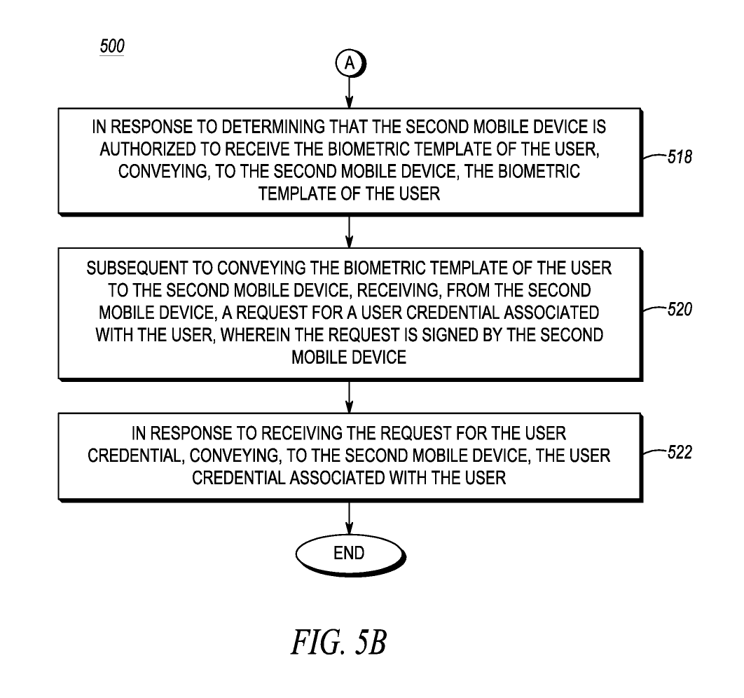

FIGS. 5A and 5B illustrate an exemplary method 500 for controlling the distribution of a biometric template for a user, such as user 102, using the wireless communication system 100. At block 502, the first mobile device 104, currently being used by user 102, conveys to the biometric template server 148, and the biometric template server receives from the first mobile device 104, a first authentication request whereby the first mobile device 104 requests to be authenticated to the biometric template server 148. The first authentication request includes a first device credential associated with the first mobile device, such as a mobile station identifier (MS ID), a subscriber unit identifier (SU ID), an International Mobile Subscriber Identity (IMSI), a Temporary Mobile Subscriber Identity (TMSI), a device certificate, or a public key pair that identifies the first mobile device in wireless communication system 100. The device credential contains enough information for the biometric template server 148 to determine that the first mobile device 104 is authorized to upload the biometric template. For example, the biometric template server 148 can uniquely identify the first mobile device 104 and refer to device authorization database 144. In another example, when the device certificate contains authorization attributes, the biometric template server 148 can use those attributes to determine that the first mobile device 104 is authorized to access or upload biometric templates.

At block 504, the first mobile device 104 conveys to biometric template server 148, and the biometric template server receives from the first mobile device, a request to upload a biometric template from the first mobile device to the biometric template server. The request may include a user identifying input that identifies a user of the first mobile device, that is, user 102. For example, when user 102 logs into first mobile device 104, the user may provide a user identifying input to the first mobile device 104. The user identifying input includes data, such as a user name, codeword or a key, that may be input to the first mobile device 104 by a user and that can be used by biometric template server 148 to retrieve a biometric template of the user. For example, the user identifying input may be a username, a password, a 2-factor authentication, a biometric input, a smart card input and/or another identifier associated with the user. The user identifying input also can include one or more other factors associated with the user, for example, something that user knows, something that the user has, and/or something that the user is. An operator of wireless communication system 100 may set the type of user identifying input for the user when the user begins working for the system operator.

At block 506, in response to receiving the first authentication request and the request to upload a biometric template, biometric template server 148 determines that first mobile device 104 is authorized to upload the biometric template to the biometric template server. That is, in response to receiving the first authentication request and the request to upload a biometric template, and by reference to one or more of the first device credential and the device authorization database 144, the biometric template server 148 determines that first mobile device 104 is authorized to operate in the wireless communication system 100. Based on such a determination, the biometric template server 148 further determines that the first mobile device 104 is authorized to upload a biometric template to the biometric template server. In some embodiments, the first mobile device 104 may be a specialized device dedicated to uploading biometric templates.

In some embodiments, the biometric template server 148 may determine that the first mobile device 104 is authorized to upload a biometric template to the biometric template server 148 based on one or more attributes that control a use of the biometric template and are associated with the user 102. For example, by reference to the user subscription database 142, the biometric template server 148 may retrieve one or more attributes associated with the user 102, such as an agency or enterprise that employs the user, a department that the user works for within the agency or enterprise, an agency precinct where the user is stationed, such as a police department or fire department precinct, a geographical jurisdiction of the agency or enterprise that employs the user or where the user currently is stationed, a role of the user or a rank of the user within the agency or enterprise that employs the user. The biometric template server 148 further may obtain, from the policy and attribute access control database 146, information concerning the requisite attributes for uploading a biometric template to the biometric template server 148 via the first mobile device 104, such as an agency, enterprise, precinct, and geographical jurisdiction to which the first mobile device 104 is registered, or a required role or rank of a user who is authorized to upload biometric templates to the biometric template server 148. The biometric template server 148 may compare the attributes associated with the user 102 to the attributes associated with the mobile device and authorize the first mobile device 104 to upload a biometric template to the biometric template server 148 when the attributes match.

In some embodiments of the present invention, the attributes considered by the biometric template server 148 may include a requisite assurance level before the biometric template server 148 authorizes the user or mobile device to upload the biometric template or an authority indicator.

At block 508, in response to determining that first mobile device 104 is authorized to upload the biometric template, the first mobile device 104 uploads to the biometric template server 148 a biometric template of the user 102 of the first mobile device 104. That is, in response to determining that the first mobile device 104 is authorized to upload a biometric template to the biometric template server 148, the biometric template server 148 notifies the first mobile device 104 that the first mobile device 104 may proceed to upload the biometric template. Prior to, concurrent with, or subsequent to receiving such notification, the first mobile device 104 collects, from the user 102 and via the one or more biometric data collection devices 220 of the first mobile device 104, biometric data of the user, for example, an iris scan, a fingerprint, a palm print, a facial-recognition-ready photograph, voice data, or an electrocardiogram that may be used to identify the user. In response to receiving the notification, the first mobile device 104 conveys, to the biometric template server 148, a biometric template including the biometric data collected from the user 102. The first mobile device 104 may also send some amount of metadata associated with the user of the biometric template. In some embodiments, before uploading the biometric template to the biometric template server 148, the first mobile device 104 encrypts the biometric template using, for example, one or more of a user provided PIN, the public key of the biometric template server 148, or a shared key known to the biometric template server 148 and the first mobile device 104.

At block 510, in response to receiving the biometric template from the first mobile device 104, the biometric template server 148 stores the biometric template in association with an identifier of user 102, such as the user identifying input provided by the first mobile device 104. Additionally, the biometric template server 148 may encrypt the biometric template using an encryption/decryption key known to, and maintained by each of a plurality of, mobile devices and the biometric template server 148 to produce an encrypted biometric template, and store the encrypted biometric template. Use of an encrypted biometric template provides enhanced authentication security, as only a mobile device in possession of the encryption/decryption key will be able to use the biometric template to authenticate a user. In some embodiments, the biometric template server 148 encrypts the biometric template regardless of whether it has already been encrypted by the first mobile device 104. Blocks 502 through 510 may be repeated in order to store multiple biometric identifiers (for example, an iris scan, fingerprint, palm print, facial-recognition-ready photograph, voice data, an electrocardiogram, and the like) for the user 102. In some embodiments, the multiple biometric identifiers are contained in a single biometric template.

With the biometric template for the user 102 stored on the biometric template server 148, the stored biometric template is available to be downloaded to, for example, the second mobile device 106, which can use the template to authenticate the user 102 on the second mobile device 106.

At some point in time after uploading the biometric template of user 102 to biometric template server 148 via first mobile device 104, the user 102 provides user identifying input to the second mobile device 106. The user identifying input matches the input entered at block 504, above, and can therefore be used by biometric template server 148 to retrieve the biometric template of the user 102. At block 512, responsive to receiving the user identifying input, the second mobile device 106 conveys to the biometric template server 148, and the biometric template server receives from the second mobile device 106, a second authentication request, whereby the second mobile device 106 requests to be authenticated with the biometric template server 148. The second authentication request includes a second device credential associated with the second mobile device 106 that may indicate that the mobile device is authorized to access biometric template data.

At block 514, the second mobile device 106 conveys to the biometric template server 148, and the biometric template server 148 receives from the second mobile device 106, a request to download a biometric template associated with the user 102 from the biometric template server 148. This request may include, or may be accompanied or preceded by, the user identifying input that identifies the current user 102 of the second mobile device. Similarly to when user 102 uploaded a biometric template at the first mobile device 104, the user identifying input includes data, which can be used by biometric template server 148 to retrieve the biometric template of the user.

At block 516, the biometric template server 148 determines that the second mobile device 106 is authorized to download the biometric template from the biometric template server 148. That is, in response to receiving the second authentication request and the request to download the biometric template, and by reference to one or more of the second device credential and the device authorization database 144, the biometric template server 148 determines that second mobile device 106 is authorized to operate in the wireless communication system 100. Based on such a determination, the biometric template server 148 further determines that the second mobile device is authorized to download a biometric template and, based on the user identifying input received from the second mobile device 106, retrieves the biometric template associated with the user 102.

Similar to the authorizing of the uploading of the biometric template to the biometric template server, in some embodiments of the present invention, in determining that second mobile device 106 is authorized to download a biometric template to the biometric template server, the biometric template server 148 further may consider metadata (for example, one or more attributes that are associated with user 102) and that will control a use of the biometric template. For example, by reference to the user subscription database 142, the biometric template server 148 may retrieve metadata including one or more attributes associated with the user 102, such as an agency or enterprise that employs the user, a department that the user works for within the agency or enterprise, an agency precinct where the user is stationed, such as a police department or fire department precinct, a geographical jurisdiction of the agency or enterprise that employs the user or where the user currently is stationed, a role of the user or a rank of the user within the agency or enterprise that employs the user. The biometric template server 148 further may obtain, from the policy and attribute access control database 146, information concerning the requisite attributes for downloading a biometric template from the biometric template server 148 via the second mobile device 106. Such attributes may include, for example, an agency, enterprise, precinct, and geographical jurisdiction to which the mobile device is registered, or a required role or rank of a user who is authorized to download biometric templates from the biometric template server. The biometric template server 148 compares the attributes associated with the user 102 to the attributes associated with the second mobile device 106. In one embodiment, the second mobile device 106 is authorized to download a biometric template from the biometric template server 148 when the attributes match.

In some embodiments, the attributes considered by the biometric template server 148 further, or instead, may include a requisite assurance level before the biometric template server authorizes the user/mobile device to upload the biometric template or an authority indicator.

In embodiments where the biometric is encrypted by either the first mobile device 104, the biometric template server 148, or both, the biometric template is decrypted by the second mobile device 106 using the same user input or key used to encrypt it. The decrypted biometric template may be used by the second mobile device 106 to authenticate the user 102 and to control access to, and a downloading (at blocks 520, 522) by the second mobile device 106 of, a user credential for user 102.

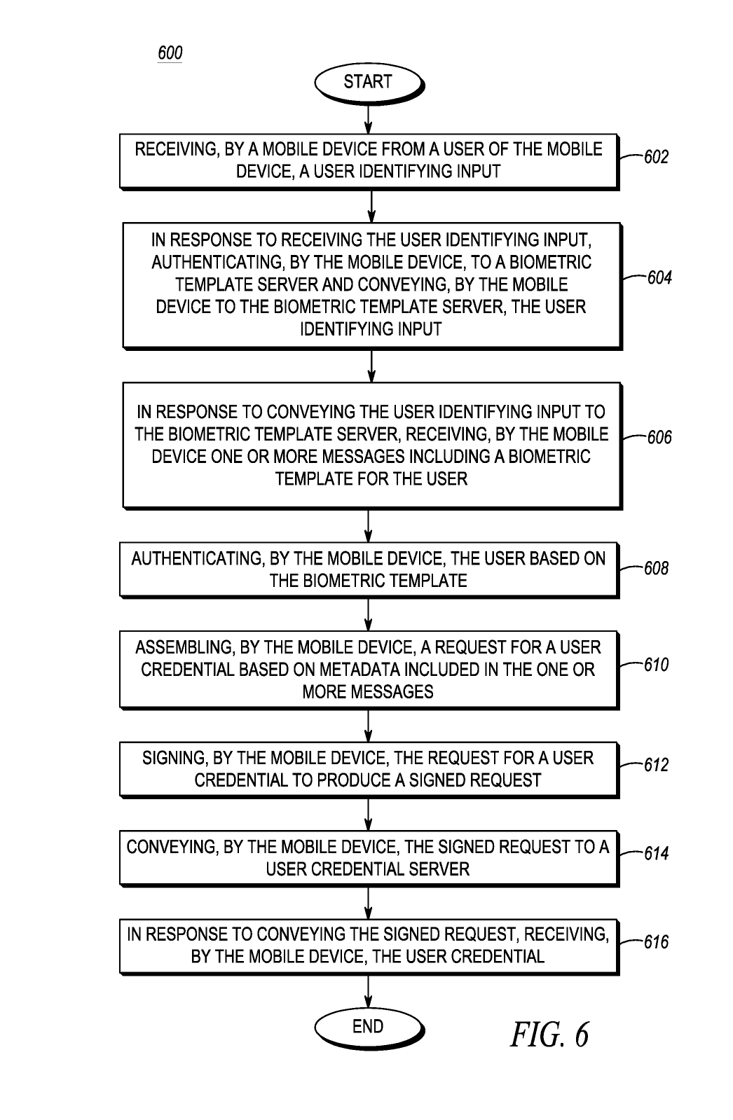

FIG. 6 illustrates an exemplary method 600 for operating the wireless communication system 100 to control access to a user credential, such as a PKI certificate or identity token. The method 600 assumes that the biometric template server 148, as described above, maintains a biometric template, preferably in an encrypted format, for a user, such as the user 102. As noted above, the biometric template may include multiple biometric identifiers for the user 102.

At block 602, the user 102 obtains the first mobile device 104 and provides to first mobile device 104 a user identifying input, as described in detail above. In some embodiments, the user identifying input may be part of a login of the user to the first mobile device 104. An operator of wireless communication system 100 may set the type of user identifying input for the user 102 when the user 102 begins working for or with the system operator.

In one embodiment of the present invention, at block 604, in response to receiving the user identifying input, the first mobile device 104 authenticates to the biometric template server 148, and conveys a request for a biometric template, which request includes the user identifying input. In some embodiments, the first mobile device 104 may authenticate using a device certificate that includes a mobile device identifier, such as an IMEI and/or an IMSI. As noted above, the device credential contains enough information for the biometric template server 148 to determine that the first mobile device 104 is authorized to upload the biometric template.

As described above, the user identifying input allows biometric template server 148 to retrieve the biometric template associated with the user 102. At block 606, in response to conveying the user input to the biometric template server 148, the first mobile device 104 receives one or more messages, the one or more messages including the biometric template for the user.

At block 608, the first mobile device 104 authenticates the user based on the received biometric template. Biometric authentication methods are known, and will not be described in greater detail, except to say that biometric authentication of the user is performed by taking fresh biometric samples from the user and comparing them to the data in the biometric templates. In some embodiments, the received biometric template is received encrypted and is decrypted by the first mobile device 104 before authentication. In such embodiments, the first mobile device 104 may decrypt the received template with at least one of the private key of the first mobile device 104, a shared key known to the biometric template server 148 and the first mobile device 104, or with user provided input such as a PIN. The first mobile device 104 decrypts the encrypted biometric template based on the user input to produce a decrypted template, and the user 102 is authenticated by the first mobile device 104 based on the decrypted biometric template.

In response to successfully authenticating the user 102, the first mobile device 104 allows the user access to the device and it's applications. In some embodiments, the first mobile device 104 may cause the screen and keyboard to unlock, and may provide the user access to other resources on the mobile device. At block 610, the first mobile device 104 assembles a request for a user credential, such as a digital certificate, for the first mobile device 104 based on the metadata received in the one or more messages (for example, the conditions on use). For example, the user credential request may be a PKI Certificate Management Protocol (CMP) certification request, as described in Internet Engineering Task Force (IETF) Request For Comments (RFC) 4210. At block 612, the first mobile device 104 signs the user credential request using its private key of a private/public key pair associated with the device to produce a signed user credential request (that is, a signed request), and, at block 614, conveys the signed user credential request to the user credential server 130. In another embodiment of the present invention, the first mobile device 104 may be authorized to act as an RA, in which event the first mobile device 104 may sign the user credential request with the private key, (that is, a registration authority key) of a private/public key pair associated with the device RA certificate of the first mobile device 104.

In some embodiments, the first mobile device 104 authenticates to the user credential server 130 with a device credential that indicates that the mobile device is authorized to request user credentials. In some embodiments, the device credential further indicates that the first mobile device 104 performs biometric user authentication prior to sending the user credential request to the user credential server 130. In response to receiving the signed user credential request, the user credential server 130 validates the user credential request. In one embodiment of the present invention, the user credential server 130 validates the user credential request by validating the first mobile device 104′s signature of the user credential request, using a public key of the private/public key pair associated with the device such as the public key contained in the first mobile device 104′s device certificate. When the user credential request is signed by the device RA private key, the user credential server 130 further may validate the user credential request by use of a corresponding device RA public key.

The user credential server 130 generates a user credential response, such as a CMP Certification Response, that includes the user credential for the first mobile device 104. At block 616, the user credential server 130 conveys the user credential response to the first mobile device 104 via the data network 126 and the RAN 122. In some embodiments, the user credential server 130 does not send a response to the first mobile device 104, but instead the first mobile device 104 polls the certificate repository for the newly issued user certificate. In other embodiments, the user credential server 130 only returns a uniform resource locator (URL) that the first mobile device 104 can use to obtain the user credential.

In some embodiments, the first mobile device 104 securely stores the user credential in its security module 206, HSM 210, or both. In some embodiments, the first mobile device 104 requires biometric authorization of the user 103 to securely store the user credential.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for controlling access to a user credential, the method comprising:
receiving, from a mobile device, an authentication request, the authentication request including a device credential associated with the mobile device;
receiving, from the mobile device, a request for a biometric template of a user;
determining, by reference to at least one of a group consisting of the device credential and an authorization database, that the mobile device is authorized to receive the biometric template of the user based on at least one attribute controlling a use of the biometric template; and
in response to determining that the mobile device is authorized to receive the biometric template of the user, conveying the biometric template of the user to the mobile device.

2. The method of claim 1, wherein the at least one attribute controlling a use of the biometric template includes one or more of an agency, a department, a precinct, a jurisdiction, an assurance level, an authority indicator, or a role of the user.

3. The method of claim 1, wherein conveying the biometric template of the user to the mobile device includes conveying, to the mobile device, metadata.

4. The method of claim 3, wherein the metadata includes at least one selected from the group consisting of a role of a user authorized to use the biometric template, a rank of a user authorized to use the biometric template, a biometric template lifetime, conditions upon which to delete the biometric template, a type of mobile device authorized to use the biometric template, a user credential subject name, a user credential validity period, one or more authorization attributes, and an assurance level.

5. The method of claim 1, further comprising:
subsequent to conveying the biometric template of the user to the mobile device, receiving, from the mobile device, a request for a user credential associated with the user, wherein the request is signed by the mobile device; and
in response to receiving the request for a user credential,
validating that the mobile device is authorized to approve user credential requests, and
conveying, to the mobile device, the user credential associated with the user.

6. The method of claim 5, wherein validating that the mobile device is authorized to approve user credential requests includes
performing device authentication with the mobile device;
wherein the mobile device, prior to requesting the user credential, provides a device certificate containing an attribute that indicates to the user credential server that the mobile device is configured to perform user authentication based on a stored biometric template.

7. A method for authenticating a user on a mobile device, the method comprising:
receiving, by a input/output interface of the mobile device, a user identifying input;
in response to receiving the user identifying input, authenticating, by the mobile device, to a biometric template server;
in response to authenticating to the biometric template server, conveying, by the mobile device to the biometric template server, the user identifying input;
in response to conveying the user identifying input, receiving, by the mobile device, one or more messages including a biometric template for the user; and
authenticating, by the mobile device, the user based on the biometric template.

8. The method of claim 7, wherein
the biometric template is valid for only a biometric template lifetime, and
the mobile device deletes the biometric template when the biometric template lifetime has expired.

9. The method of claim 7, further comprising:
assembling, by the mobile device, a request for a user credential based on metadata included in the one or more messages;
signing, by the mobile device, the request for a user credential to produce a signed request;
conveying, by the mobile device to a user credential server, the signed request; and
in response to conveying the signed request, receiving, by the mobile device, the user credential.

10. The method of claim 9, further comprising:
in response to receiving the user credential, securely storing the user credential.

11. The method of claim 10, wherein securely storing includes requiring a biometric authentication of the user, based on the biometric template, in order to activate a use of the user credential.

12. The method of claim 9, wherein the metadata includes information controlling a use of the biometric template by the mobile device.

13. The method of claim 9, wherein the metadata includes information controlling a use of the user credential by the mobile device.

14. The method of claim 9, wherein the metadata is at least one selected from a group consisting of a role of a user authorized to use the biometric template, a rank of a user authorized to use the biometric template, a biometric template lifetime, conditions upon which to delete the biometric template, a type of mobile device authorized to use the biometric template, a user credential subject name, a user credential validity period, one or more authorization attributes, and an assurance level.

15. The method of claim 9, wherein signing the request includes signing the request using a registration authority key associated with the mobile device.

16. The method of claim 9, wherein the request for a user credential is a certificate signing request and wherein the user credential is a certificate.

17. The method of claim 9, wherein the request for a user credential is a request for an identity token, and wherein the user credential is an identity token.

18. The method of claim 9, wherein the user credential server includes at least one selected from a group consisting of a public key infrastructure, a public key infrastructure element, a registration authority and a certificate authority.

19. The method of claim 7, further comprising:
receiving a user input including a user-provided personal identification number;
decrypting the biometric template based on the user-provided personal identification number to produce a decrypted biometric template; and
authenticating the user based on the decrypted biometric template.

20. A mobile device comprising:
an input/output interface;
a wireless interface
a processor;
at least one memory device configured to store a set of instructions that, when executed by the processor, cause the processor to perform the following functions:
receive, via the input/output interface, a user identifying input from a user of the mobile device;
in response to receiving the user identifying input, authenticate to a biometric template server and convey, to the biometric template server via the wireless interface, the user identifying input;
in response to conveying the user identifying input, receive, via the wireless interface, one or more messages including a biometric template for the user;
authenticate the user based on the biometric template;
assemble a request for a user credential based on metadata included in the one or more messages;
sign the request for a user credential to produce a signed request;
convey, via the wireless interface, to a user credential server, the signed request; and
in response to conveying the signed request, receive, via the wireless interface, the user credential.
